(19) United States
(12) Patent Application Publication
(10) Pub. No.: US 2007/0258597 A1
(43) Pub. Date: Nov. 8, 2007

(54) Low Frequency Phase Matching for Microphones

(75) Inventors: Karsten Bo Rasmussen, Hellerup (DK); Kim Spetzler Petersen, Hellerup (DK); Ulrik Kjems, Hellerup (DK)

Correspondence Address: BIRCH STEWART KOLASCH & BIRCH, PO BOX 747, FALLS CHURCH, VA, 22040-0747, US

(73) Assignee: OTICON A/S, SMORUM (DK)

(21) Appl. No.: 11/660,734

(22) PCT Filed: Aug. 22, 2005
(86) PCT No.: PCT/EP05/54117

§ 371 Date: Feb. 22, 2007

(30) Foreign Application Priority Data
Aug. 24, 2004 (DK) PA 2004 01280

(51) Int. Cl. H04R 5/00

(52) U.S. Cl. 381/26

(57) ABSTRACT

The invention relates to a communication device having at least two microphones, where in order to match the microphone performance in respect of the phase response a correction filter in the form of a IIR filter is implemented and where the amplitude of the transfer function for the correction filter is the inverse of the difference between the two microphone amplitudes.

### FIELD OF THE INVENTION

The invention relates to the field of communication devices using two or more microphones to pick up an acoustic signal. The field may include hearing aids, assistive listening devices, headsets and other communication devices, which may be headworn or bodyworn.

### BACKGROUND OF THE INVENTION

The basic of this invention is to perform microphone phase matching on two or more microphones, only by looking at the amplitude at low frequencies. Matching of microphones is known from several sources.

The closest prior art is considered as EP0982971 disclosing an apparatus and method for matching the response of microphones in magnitude and phase. The application deals with the successive amplitude and phase matching of microphones, using the interdependence between the amplitude and the phase in the low frequency area for the microphones.

A directional microphone system is a normal feature in hearing aids today. The directional microphone system is a system that attenuates sounds originating from a specific location but allows signal from other directions. The system can improve the signal to noise ratio in a given situation, but the most systems depends on perfect microphones. One way of realising a directional microphone system is by combining the output of two spatially separated microphones. One problem with microphones in such a two microphone system is that the microphones are not perfect, meaning that they do not provide an identical response, due to spread in production tolerances, ageing etc.. One specific problem with the microphone is that the microphone doesn't allow low frequencies through the transducer. The missing low frequencies are a feature that the producer designs, but due to production spread the cut-off frequency is not the same in different microphones. The difference in cut-off frequency generates a phase and amplitude difference around the cut-off frequency. The non-ideal microphones then lower the effect of the directional system especially in the frequency region extending from the cut off frequency and up to two or three times the cut off frequency.

It is obvious that this is disadvantageous and the need for an improvement is apparent.

### DESCRIPTION OF THE INVENTION

The purpose of this invention is to correct the difference in cut-off frequency between at least two microphones, and thereby obtain a more effective directionality, by use of the characteristics of a microphone model.

According to the invention this is obtained by the communication device defined in claim 1 and by the method defined in claim 5.

By correcting the amplitude difference the phase difference of the microphones is corrected inherently to a satisfactory level due to the relationship between the phase difference and the amplitude difference in this frequency area. The invention is independent of the amount of sound sources or the presence of acoustical reflections, however at least one source is required for the method to perform satisfactory

The IIR filter is preferably of first order. This provides a reliable and adequate correction of the microphone performance

The invention is primarily intended for communication devices that are battery driven and bodyworn, preferably headworn, e.g. a hearing aid or a telephone headset.

### DESCRIPTION OF THE DRAWINGS

FIG. 1 The figure shows the low frequency cut-off in a microphone;

FIG. 2 shows the amplitude difference between the two microphones;

FIG. 3 shows the inverse function of the measured difference between the two microphones. The correction filter is a first order filter, because of the acoustic system;

FIG. 4 shows the microphone response of the two microphones after the correction filter is added;

FIG. 5 shows the amplitude difference between the two microphones after correction;

FIG. 6 shows the phase difference between the two microphones after correction; and

FIG. 7 shows a matching system with two channels.

### DETAILED DESCRIPTION OF THE INVENTION

The low frequency part of a microphone can be described as a first order high pass filter at low frequencies. The most normal cut-off frequency in a hearing aid is between 50 Hz to 250 Hz.

If we look at a model of a first order high pass filter we get (right part of the equation):

$${H}_{HP} ( z ) = \frac{{b}_{0} + {b}_{1} {z}^{- 1}}{1 + {a}_{1} {z}^{- 1}} = {s}_{0} \frac{1 - {z}^{- 1}}{1 + {a}_{1} {z}^{- 1}}$$

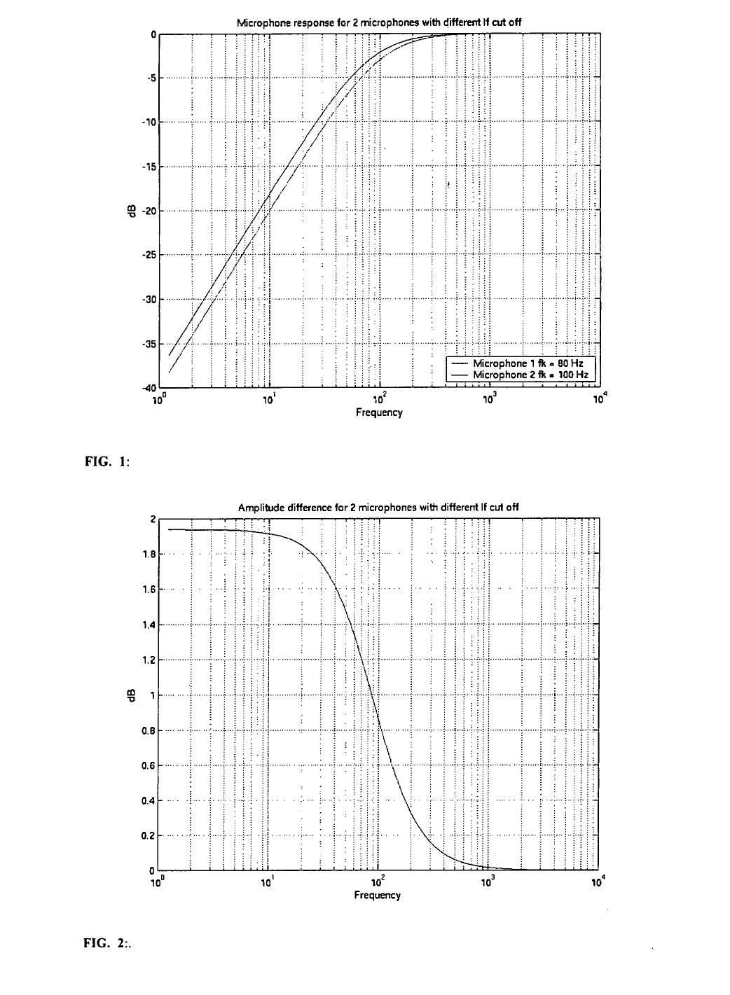

FIG. 1 shows a model of two different cut-off frequencies (80 Hz and 100 Hz). In the example are the values: (with a 20 kHz sampling frequency)

80 Hz: s_{0-80Hz}=0.9876 a_{1-80Hz}=−0.9752

100 Hz: s_{0-100HZ}=0.9845 a_{1-100HZ}=−0.9691

FIG. 2 shows the amplitude difference as a function of frequency.

In order to change the cutoff frequency of the 80 Hz filter to a 100 Hz, we need to change the pole in the 80 Hz cut-off model to 100 Hz. Introducing one first order IIR filter after the microphone can have this functionality. The filter will then be:

$${H}_{correction} = \frac{1 + {a}_{1 - 80 Hz} {z}^{- 1}}{1 + {a}_{1 - 100 Hz} {z}^{- 1}} \cdot \frac{{s}_{0 - 100 Hz}}{{s}_{0 - 80 Hz}} = \frac{1 - 0.9752 {z}^{- 1}}{1 - 0.9691 {z}^{- 1}} 0.9969$$

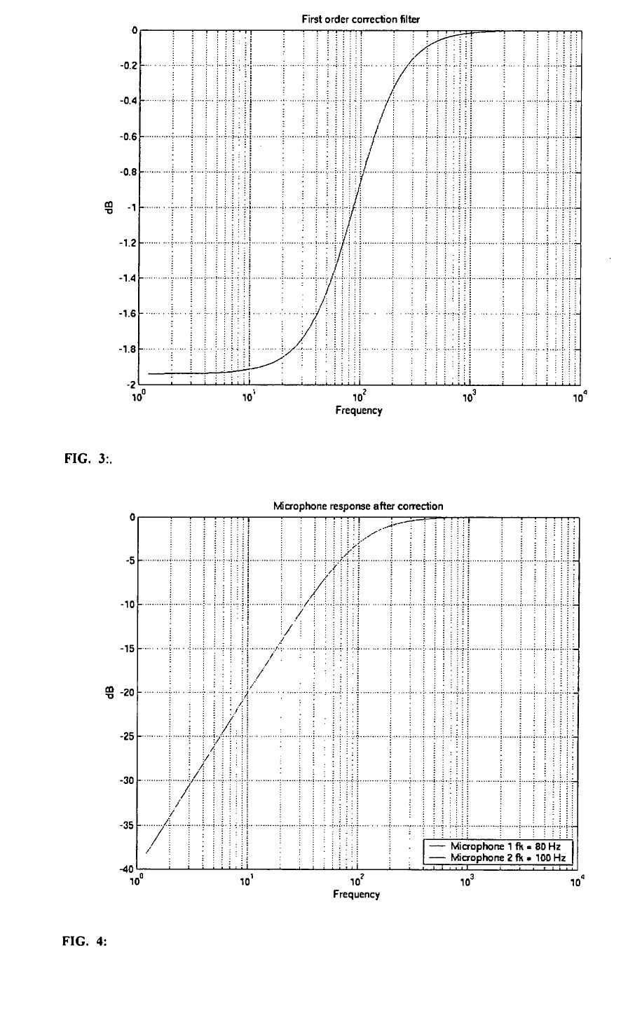

The correction filter is shown in FIG. 3. From the figure it should be seen that the transfer function for the correction filter is the inverse of the difference between the two microphones. Since the model of the microphones is a first order cut-off, the correction filter will also be of first order. The solution to the inverse is therefore unique and therefore will both the phase and amplitude be corrected, when the amplitude is corrected

The idea of the invention is to:
1. Measure the difference between the amplitude of the two microphones. FIG. 2
2. Find the inverse of the difference. FIG. 3.
3. Estimate a first order filter with this transfer function
4. Correct one of the microphones.

Ad 3. The filter can be estimated from a transfer function by e.g. using an adaptive algorithm and adapt the IIR filter to a certain transfer function.

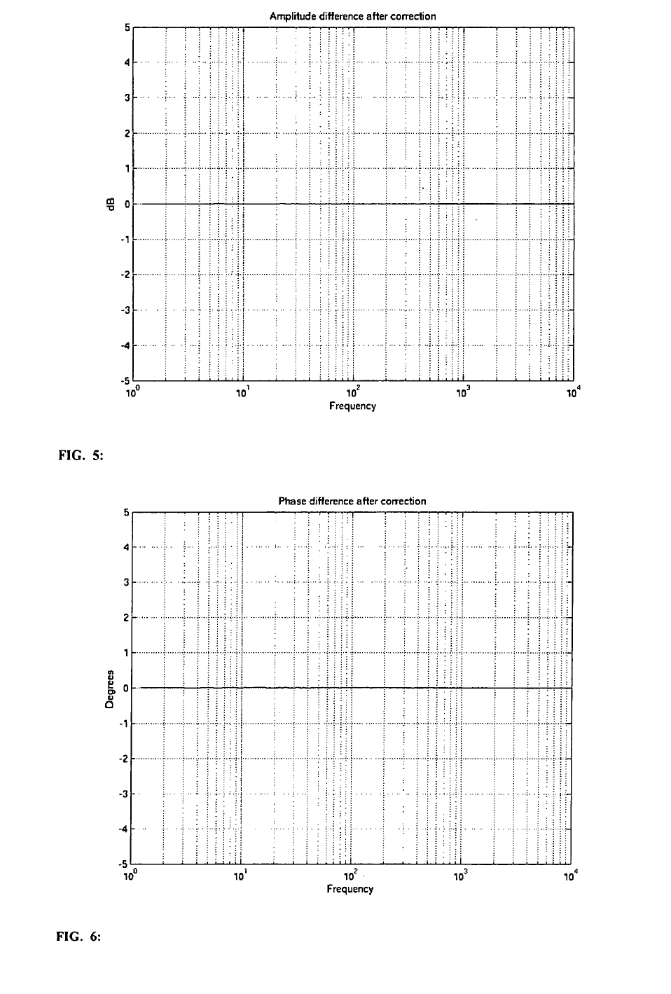

FIG. 4 shows the microphones transfer function after correction. FIGS. 5 and 6 shows the difference in amplitude and phase after correction (very close to zero).

The correction can also be added so that the 100 Hz filter is converted to an 80 Hz cut-off filter. The algorithm can be sensitive to wind noise and own voice (proximity effect). Therefore should the algorithm be slow and if possible stopped if any wind noise or near field sounds is detected.

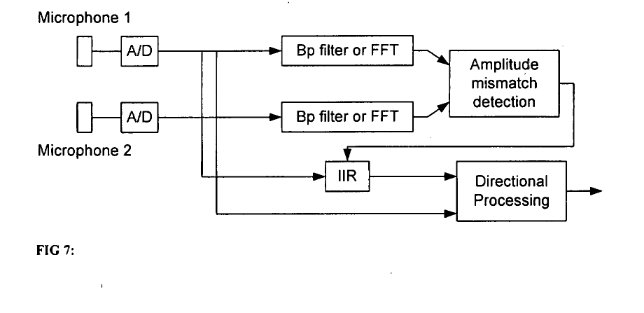

In a hearing aid the two or more microphones each provide an electrical signal that is processed in a processor/amplifier and afterwards delivered to an output transducer. The hearing aid as such may be of a type known per se, where the difference is represented by the correction filter according to the invention. FIG. 7 shows a matching system with two channels where each microphone is followed bya an A/D converter and a bandpass filter or FFT and where the output from the bandpass filters are fed into a microphone mismatch detector, which again provides an input to an IIR correction filter for the one microphone. The microphone signals, where one possibly has been corrected are then suited for directional processing in a processor adapted for this purpose. Further processing and amplification are normally provided for in connection with a hearing aid as well as an output transducer.

1. A communication device having a first microphone with a first response and a second microphone with a second response, where in order to match the microphone performance adaptively in respect of the phase response in the frequency area below 500 Hz a correction filter in the form of a IIR filter is implemented and where the amplitude of the transfer function for the correction filter is at least approximately the inverse of the difference between the two microphone amplitudes.

2. A communication device according to claim 1, where the IIR filter is a first order filter.

3. A communication device according to claim 1 or 2, where the phase is matched by use of the correction filter as a consequence of the amplitude matching.

4. A communication device according to claim 1 or 2, where the device is a battery driven bodyworn, preferably headworn, device, e.g. a hearing aid or a telephone headset.

5. A method for adaptive calibration of the amplitude and phase of two individual microphones in a low frequency area, where a correction filter in the form of a IIR filter is implemented for correcting the phase difference between the microphones and where the transfer function for the correction filter is approximately the inverse of ratio between the two microphones transfer functions.
